(19) United States
(12) Patent Application Publication
(10) Pub. No.: US 2021/0076302 A1
(43) Pub. Date: Mar. 11, 2021

(54) ACCESS CONTROL METHOD FOR SMART CARD AND ELECTRONIC DEVICE USING SAME

(71) Applicant: Samsung Electronics Co., Ltd., Suwon-si, Gyeonggi-do (KR)

(72) Inventors: Jaehong KIM, Suwon-si (KR); Daesoo PARK, Suwon-si (KR)

(21) Appl. No.: 16/963,401

(22) PCT Filed: Feb. 11, 2019
(86) PCT No.: PCT/KR2019/001624

§ 371 Date: Jul. 20, 2020

(30) Foreign Application Priority Data
Feb. 14, 2018 (KR) 10-2018-0018576

(51) Int. Cl. H04W 48/04; H04W 48/14; H04W 48/16; H04W 8/20; H04W 88/02

(52) U.S. Cl. CPC H04W 48/04; H04W 48/14; H04W 88/02; H04W 8/205; H04W 48/16

(57) ABSTRACT

Various embodiments of the present invention relate to an access control method for a smart card and an electronic device using the same, the method comprising the steps in which: a processor refreshes the smart card to update identification information when the electronic device is located in a predetermined region; the processor stores, in a memory, information before the identification information is updated; the processor stores the updated identification information in smart card information of the smart card; the processor checks whether identification information before the update is stored in the memory when the updated identification information is included in blacklist information of the memory; the processor determines whether the identification information before the update is included in the blacklist information; and the processor allows an access to the smart card, when the identification information before the update is not included in the blacklist information, such that a user normally buying and using an electronic device at a specific region could not have a limitation related to regional locking, caused by refreshing of identification information of the smart card, which can occur while visiting a country on a blacklist. Other various embodiments are possible.

### TECHNICAL FIELD

Various embodiments of the disclosure relate to an access control method for a smart card and an electronic device using same.

### BACKGROUND ART

As the use of an electronic device such as a portable terminal has increased, various functions are provided in the electronic device.

The electronic device may include a smart card which stores information for identifying a subscriber.

Based on identification information stored in the smart card, the electronic device may access a network which is provided by a specific mobile communication service provider, and perform wireless communication with another electronic device.

For example, in the European mobile phone (global system for mobile communication (GSM)) scheme, a user of the electronic device may select a mobile communication service provider by means of the smart card.

### Technical Problem

The GSM scheme allows a regional lock. For example, the regional lock may be a function for locking an electronic device (e.g., a smartphone) employing a GSM scheme to block booting of the electronic device and the use of a specific network when a SIM card from countries in a blacklist is inserted therein.

A user of an electronic device employing the GSM scheme may travel to another region or country while the regional lock is not unlocked.

The electronic device having been moved to another region may be used by changing an international mobile station identity (hereinafter referred to as “IMSI”) stored in a smart card to an IMSI of a region where the electronic device is currently located, through a function of refreshing the smart card.

In this case, the smart card may perform the refresh function regardless of the intention of the user of the electronic device.

In addition, even though the electronic device is not supposed to be subject to the regional lock by using a normal smart card, the electronic device may be subject to the regional lock when a region (e.g., Europe) where the electronic device is located corresponds to a country included in a blacklist for which the regional lock is configured.

Various embodiments according the disclosure may provide: a method for controlling (e.g., restricting or allowing) access to a smart card embedded in an electronic device, according to whether identification information before the update is included in a blacklist when the smart card is refreshed and identification information (e.g., IMSI) of the electronic device is updated, due to the interregional movement; an electronic device using same; and a non-transitory computer-readable storage medium in which a program for performing the method is stored.

### Solution to Problem

In accordance with various embodiments of the disclosure, an electronic device may include a wireless communication unit configured to establish a communication channel with a network; a smart card including smart card information in which identification information of the electronic device is stored; a memory configured to store blacklist information; and a processor electrically connected to the wireless communication unit, the smart card, and the memory, wherein the processor may be configured to: refresh the smart card to update identification information when the electronic device is located in a predetermined region; store information before the update of the identification information in the memory; store the updated identification information in the smart card information; identify whether identification information before the update is stored in the memory when the updated identification information is included in the blacklist information; determine whether the identification information before the update is included in the blacklist information; and allow access to the smart card when the identification information before the update is not included in the blacklist information.

In accordance with various embodiments of the disclosure, an access control method for a smart card included in an electronic device may include, as operations performed by a processor: refreshing the smart card to update identification information when the electronic device is located in a predetermined region; storing information before the update of the identification information, in a memory; storing the updated identification information in smart card information of the smart card; identifying whether identification information before the update is stored in the memory when the updated identification information is included in blacklist information of the memory; determining whether the identification information before the update is included in the blacklist information when the identification information before the update is stored in the memory; and allowing access to the smart card when the identification information before the update is not included in the blacklist information.

In accordance with various embodiments of the disclosure, a non-transitory computer-readable storage medium in which a program configured to perform an access control method for a smart card included in an electronic device is stored may perform the method including: refreshing the smart card to update identification information when the electronic device is located in a predetermined region; storing information before the update of the identification information, in a memory; storing the updated identification information in smart card information of the smart card; identifying the identification information before the update is stored in the memory when the updated identification information is included in blacklist information of the memory; determining whether the identification information before the update is included in the blacklist information; and allowing access to the smart card when the identification information before the update is not included in the blacklist information.

### Advantageous Effects of Invention

According to various embodiments of the disclosure, due to the interregional movement, when a smart card is refreshed and identification information (e.g., IMSI) of an electronic device is newly updated, access to the smart card may be restricted when identification information before the update is included in a blacklist, and the access to the smart card may be allowed when the identification information before the update is not included in the blacklist.

According to an embodiment of the disclosure, a user who uses an electronic device by normally buying same in Europe, for example, may not have a regional lock restriction even though a smart card is refreshed while visiting a country corresponding to a blacklist.

### BRIEF DESCRIPTION OF DRAWINGS

FIG. 1 is a block diagram of an electronic device in a network environment according to various embodiments of the disclosure;

FIG. 2 is a schematic block diagram of an electronic device using an access control method for a smart card according to various embodiments of the disclosure;

FIG. 3 is a view illustrating a configuration of a wireless communication unit of an electronic device which uses an access control method for a smart card according to various embodiments of the disclosure;

FIG. 4 is a flowchart illustrating an access control method for a smart card according to various embodiments of the disclosure; and

FIG. 5 is a flowchart illustrating an access control method for a smart card in detail according to various embodiments of the disclosure.

### BEST MODE FOR CARRYING OUT THE INVENTION

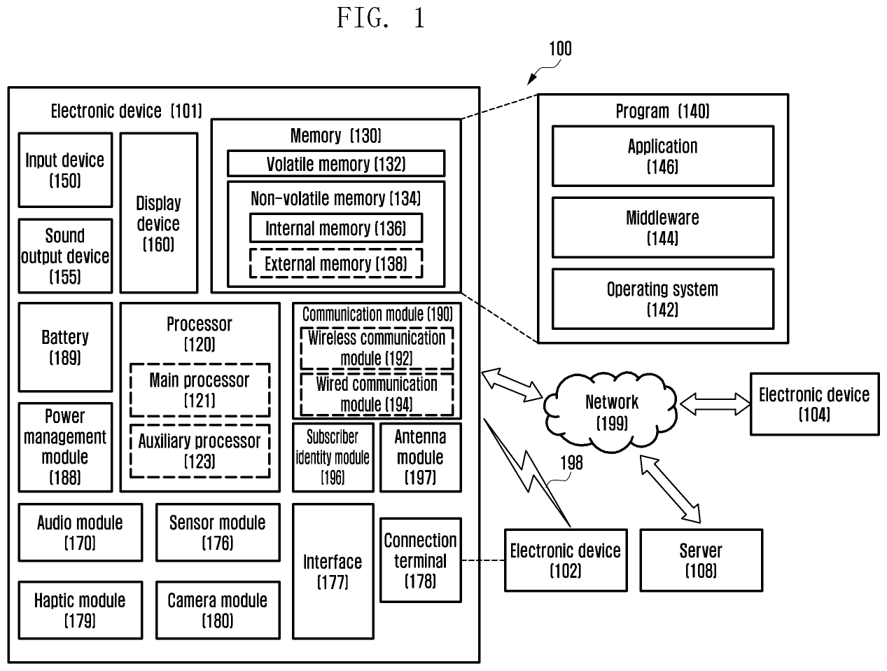

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform certain data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. The memory 130 may store certain data used by at least one component (e.g., the processor 120 or the sensor module 176) of the electronic device 101. The certain data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming call. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These certain types of communication modules may be implemented as a single component (e.g., a single chip), or may be implemented as multi components (e.g., multi chips) separate from each other.

The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit/receive a signal or power to/from an external entity (e.g., an external electronic device). According to some embodiments, the antenna module 197 may be formed of a conductor or a conductive pattern and may further include any other component (e.g., RFIC). According to an embodiment, the antenna module 197 may include one or more antennas, which may be selected to be suitable for a communication scheme used in a specific communication network, such as the first network 198 or the second network 199 by, for example, the communication module 190. Through the selected at least one antenna, a signal or power may be transmitted or received between the communication module 190 and the external electronic device.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to certain embodiments may be one of certain types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include certain changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

The module or programming module of the present disclosure may include at least one of the aforementioned components with omission of some components or addition of other components. The operations of the modules, programming modules, or other components may be executed in series, in parallel, recursively, or heuristically. Also, some operations may be executed in different order, omitted, or extended with other operations.

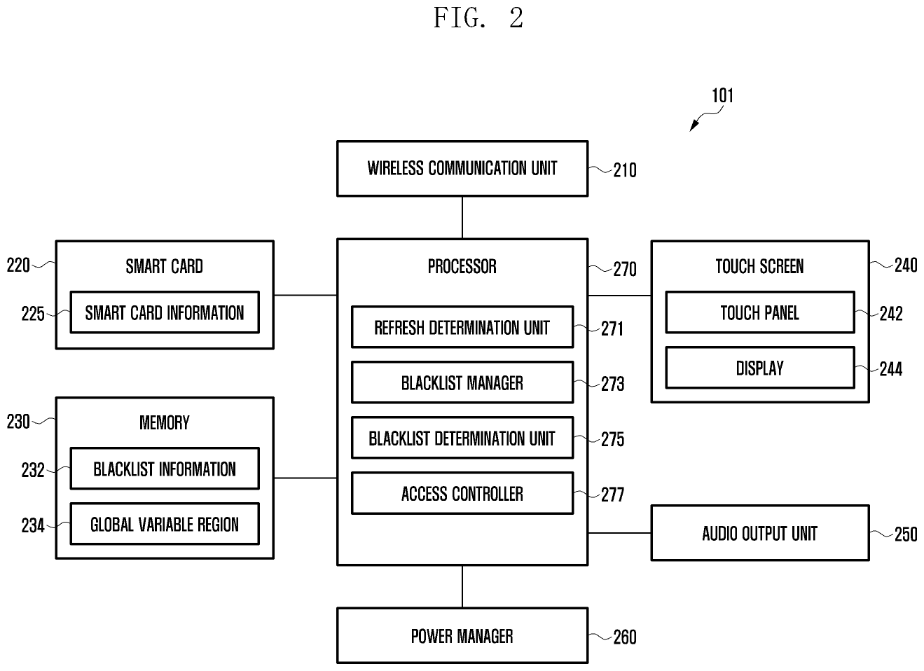

FIG. 2 is a schematic block diagram of an electronic device using an access control method for a smart card according to various embodiments of the disclosure.

Referring to FIG. 2, an electronic device (e.g., the electronic device 101 of FIG. 1) according to various embodiments of the disclosure may include a wireless communication unit 210, a smart card 220, a memory 230, a touch screen 240, an audio output unit 250, a power manager 260, and a processor 270.

According to various embodiments of the disclosure, the wireless communication unit 210 may include the wireless communication module 192 of FIG. 1. The smart card 220 may include the subscriber identification module 196 of FIG. 1. The memory 230 may include the memory 130 of FIG. 1. The touch screen 240 may include the input device 150 and the display device 160 of FIG. 1. The audio output unit 250 may include the sound output device 155 of FIG. 1. The power manager 260 may include the power management module 188 of FIG. 1. The processor 270 may include the processor 120 of FIG. 1.

The wireless communication unit 210 may establish a voice call channel, a video call channel, a data communication channel, or the like of the electronic device 101 with a service provider network related to the smart card 220.

According to an embodiment, the wireless communication unit 210 may establish a data communication channel with corresponding service provider network, based on a data communication configuration which corresponds to a mobile country code (MCC) and a mobile network code (MNC) stored in the smart card 220. The wireless communication unit 210 may include an RF transmitter for up-converting and amplifying a frequency of a transmitted signal, an RF receiver for low-noise-amplifying the received signal and down-converting a frequency thereof, and the like.

The smart card 220 may store smart card information 225 for identifying a user of the electronic device 101. The smart card 220 may identify a specific electronic device 101 within a predetermined communication service provider network by using the stored smart card information 225. The smart card 220 may include a subscriber identification module (SIM) card or a universal SIM (USIM) card.

According to an embodiment, the smart card information 225 may include information (e.g., country information, provider information, subscriber information) which is used for identifying the smart card 220. The smart card information 225 may include identification information required for determining whether to use the electronic device 101. For example, the smart card information 225 may include identification information such as an international mobile subscriber identity (IMSI), a mobile country code (MCC), a mobile network code (MNC), a mobile identification number (MIN), and a mobile subscriber identifier number (MSIN).

The memory 230 may store a program (e.g., the program 140 of FIG. 1) for controlling the overall operation of the electronic device 101. The memory 230 may store a program for processing and controlling the processor 270, various applications, and input or output data. The memory 230 may store a user interface (UI) provided by the electronic device 101, an audio signal, and various configuration information required for processing a function in the electronic device 101.

According to an embodiment, the memory 230 may store an operating system (OS) of the electronic device 101, a program related to an input and a display operation using the touch screen 240, a program related to an operation of managing (e.g., modifying, deleting, adding, etc.) a blacklist, a program related to an operation of comparing the identification information of the smart card 220 and the blacklist, a program related the allowance of the use of the electronic device 101 or the restriction of the use of the electronic device 101, according to the comparison result, and the like.

The memory 230 may include blacklist information 232 and a global variable region 234.

According to an embodiment, the blacklist information 232 may include at least one piece of identification information for restricting the use of the electronic device 101 in a specific region. The blacklist information 232 may register and manage, in a table, various pieces of information such as disallowable country information, provider information, smart card information, network information, cell information, regional information, and base station information, in order to restrict the use of electronic device 101 according to a region. The blacklist information 232 may be configured by default at the time of manufacturing the electronic device 101, or may be managed by a mobile communication service provider in an over-the-air (OTA) method, a firmware OTA (FOTA) method, or the like.

According to an embodiment, due to the interregional movement of the electronic device 101, when the smart card 220 is refreshed and the identification information of the electronic device 101 is changed, the global variable region 234 may store the identification information before the change. According to an embodiment, the identification information may include at least one of an international mobile subscriber identity (IMSI), a mobile country code (MCC), a mobile network code (MNC), a mobile identification number (MIN), and a mobile subscriber identification number (MSIN), which are stored in the smart card information 225.

When access to the smart card 220 of the electronic device 101 is restricted or allowed, the touch screen 240 may display the user interface (UI) related to the restriction or the allowance.

According to an embodiment, the touch screen 240 may perform an input function and/or a display function. To this end, the touch screen 240 may include a touch panel 242 and a display 244. The touch panel 242 may include a touch detection sensor such as a capacitive overlay, a resistive overlay, an infrared beam type, and a pressure sensor. The touch panel 242 of the embodiment may include, other than the described sensors, any kinds of sensor devices capable of detecting a contact or a pressure of an object. The touch panel 242 may detect a touch input of a user of the electronic device 101, produce a detection signal, and transmit same to the processor 270. The display 244 may include a liquid crystal display (LCD), organic light emitting diodes (OLEDs), active matrix organic light emitting diodes (AMOLEDs), and the like, and visually provide the user a menu, input data, function configuration information, and various types of other information of the electronic device 101.

When the access to the smart card 220 of the electronic device 101 is restricted or allowed, the audio output unit 250 may output an audio signal related to the restriction or the allowance. When the smart card 220 is inserted into or removed from the electronic device 101, the audio output unit 250 may output a predetermined audio signal. When the electronic device 101 is booted, the audio output unit 250 may output a predetermined audio signal. When data communication configuration information is updated according to the replacement or the update of the smart card 220, the audio output unit 250 may output an audio signal indicating the change of the data communication configuration information. The audio signals may be stored in the memory 230.

The power manager 260 may manage power supplied to the electronic device 101.

According to an embodiment, the power manager 260 may include a power management integrated circuit (PMIC), a charger integrated circuit (IC), or a battery or fuel gauge. For example, when the electronic device 101 is turned on, the power manager 260 may supply power of a battery to other components (e.g., the processor 270). In addition, the power manager 260 may receive a command from the processor 270 and manage a power supply in response to the command.

The processor 270 may control the function and the operation of the wireless communication unit 210, the smart card 220, the memory 230, the touch screen 240, the audio output unit 250, and the power manager 260, which are included in the electronic device 101. The processor 270 may control operations related to the restriction or the allowance of access to the smart card embedded in the electronic device 101 according to various embodiments of the disclosure.

According to an embodiment, the processor 270 may perform functions for controlling an overall operation of the electronic device 101 and a signal flow between internal components, and processing data. The processor 270 may include, for example, a central processing unit (CPU), an application processor, a communication processor, and the like. The processor 270 may include a single core processor or a multi-core processor, and a plurality of processors.

According to an embodiment, the processor 270 may include a refresh determination unit 271, a blacklist manager 273, a blacklist determination unit 275, and an access controller 277.

The refresh determination unit 271 may determine whether the smart card 220 supports the refreshing of the identification information (e.g., IMSI) of the electronic device 101.

The blacklist management unit 273 may manage the blacklist information 232 stored in the memory 230. For example, the blacklist management unit 273 may update (e.g., modify, add, or delete) the blacklist information 232 stored in the memory 230 in response to a request of a specific mobile communication service provider.

The blacklist determination unit 275 may determine whether the electronic device 101 is included in the blacklist information 232, based on the smart card information 225. For example, when the smart card information 225 of the electronic device 101 is included in the blacklist information 232, the blacklist determination unit 275 may obtain the identification information of the smart card information 225 according to an operation method for restricting the use of the smart card 220. The blacklist determination unit 275 may compare the obtained identification information and the blacklist information 232, and determine whether the obtained identification information is included in the blacklist information 232.

When the obtained identification information is not included in the blacklist information 232, the access controller 277 may allow the access to the smart card 220 to control the electronic device 101 to be normally operated. When the obtained identification information is included in the blacklist information 232, the access controller 277 may restrict the access to the smart card 220 to control the electronic device 101 to be inactivated.

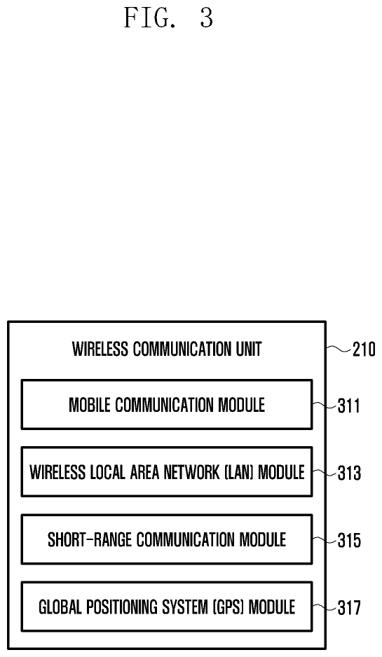

FIG. 3 is a view illustrating a configuration of a wireless communication unit of an electronic device which uses an access control method for a smart card according to various embodiments of the disclosure.

Referring to FIG. 3, a wireless communication unit (e.g., the wireless communication module 192 of FIG. 1 or the wireless communication unit 210 of the FIG. 2) of an electronic device (e.g., the electronic device 101 of FIG. 1) according to various embodiments of the disclosure may include a mobile communication module 311, a wireless local area network (LAN) module 313, a short-range communication module 315, and a global positioning system (GPS) module 317.

The mobile communication module 311 may transmit or receive a wireless signal to or from an external electronic device (e.g., the electronic device 104 and the server 108 of FIG. 1) through a network (e.g., the network 199 of FIG. 1). The wireless signal may include blacklist information (e.g., the blacklist information 232 of FIG. 2) for restricting the use of the electronic device 101 in a specific region. The wireless signal may include various types of data according to transmission or reception of a voice call signal, a video call signal, or text/multimedia message.

The wireless LAN module 313 may include various modules for establishing a wireless internet access and a wireless LAN link with another electronic device (e.g., the electronic device 102 of FIG. 1). For example, the wireless LAN module 313 may include at least one of a wireless LAN (wireless fidelity (Wi-Fi)), a wireless broadband (WiBro), a world interoperability for microwave access (Wimax), and a high speed downlink packet access (HSDPA). The wireless LAN module 313 may transmit various pieces of data according to the selection of the user of the electronic device 101 to the other electronic device, or receive external data when the wireless LAN link is established between the same and the other electronic device.

The short-range communication module 315 may include various modules for performing short-range communication with the other electronic device (e.g., the electronic device 102 of FIG. 1). For example, the short-range communication module 315 may include at least one of Bluetooth, Bluetooth low energy (BLE), radio frequency identification (RFID), infrared data association, ultra wideband (UWB), Zigbee, and near field communication (NFC). The short-range communication module 315 may transmit various pieces data according to the selection of the user of the electronic device 101 to the other electronic device, or receive external data when the other electronic device is connected to the same through the short-range communication.

The GPS module 317 may obtain the position of the electronic device 101. The GPS module 317 may obtain distance information and accurate time information away from three or more base stations, employ the triangulation to the obtained information, and obtain three-dimensional location information according to the latitude, the longitude, and the altitude. The GPS module 317 may receive the location information of the electronic device 101 from three or more satellites in real time.

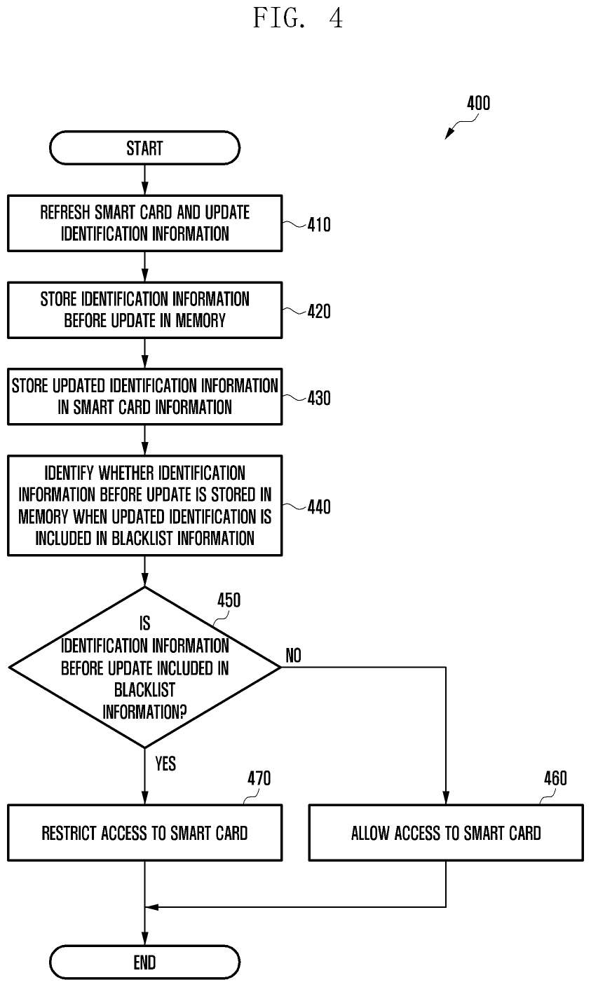

FIG. 4 is a flowchart 400 illustrating an access control method for a smart card according to various embodiments of the disclosure. Particularly, FIG. 4 may be a flowchart illustrating an operation in which an electronic device having a SIM supporting IMSI refreshing embedded therein moves to a region (country) required to be subject to the IMSI refreshing and performs the IMSI refreshing according to various embodiments of the disclosure.

Operations described with reference to FIG. 4 may be executed by, for example, elements described in the electronic device 101 of FIG. 1 or FIG. 2.

In operation 410, when the interregional movement of the electronic device 101 occurs, the processor 270 may refresh the smart card 220 to update the identification information (e.g.,

In operation 420, the processor 270 may store identification information before the update in the memory 230. According to an embodiment, the identification information before the update may be stored in the global variable region 234 of the memory 230.

In operation 430, the processor 270 may store the identification information updated in operation 410 to the smart card information 225.

In operation 440, when the updated identification information is included in the blacklist information 232, the processor 270 may identify whether the identification information before the update is stored in the memory 230.

In operation 450, the processor 270 may determine whether the identification information before the update is included in the blacklist information 232.

In operation 460, when the identification information before the update is not included in the blacklist information 232, the processor 270 may allow the access to the smart card 220 and control the electronic device 101 to be normally operated.

In operation 470, when the identification information before the update is included in the blacklist information 232, the processor 270 may restrict the access to the smart card 220 to block the function of the electronic device 101.

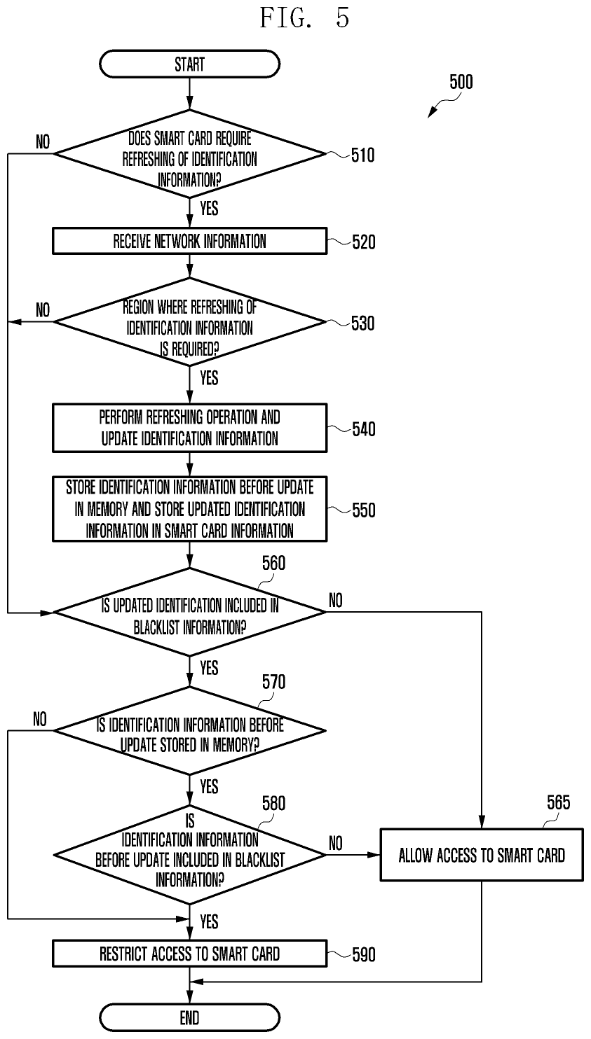

FIG. 5 is a flowchart 500 illustrating an access control method for a smart card in detail according to various embodiments of the disclosure.

Operations described with reference to FIG. 5 may be executed by, for example, elements described in the electronic device 101 of FIG. 1 or FIG. 2.

In operation 510, the processor 270 may determine whether the smart card 220 requires refreshing of the identification information stored in the smart card information 225, by using the refreshing determination unit 271.

According to an embodiment, when the smart card 220 does not require the refreshing of the identification information, the processor 270 may proceed to operation 560 to be described later, and determine whether the smart card information 225 in which current identification information is stored is included in the blacklist information 232.

In operation 520, when the smart card 220 requires the refreshing of the identification information, the processor 270 may receive network information of a region where the electronic device 101 is located.

According to an embodiment, the network information may include at least one of a mobile country code (MCC) and a mobile network code (MNC), which are received from a network (e.g., the network 199 of FIG. 1).

In operation 530, the processor 270 may determine whether the electronic device 101 is in a region where the refreshing of the identification information is required, based on the network information received in operation 520.

According to an embodiment, when it is determined that the electronic device 101 is not in the region where the refreshing of the identification information is required, the processor 270 may proceed to operation 560 to be described later, and determine whether the smart card information 225 in which the current identification information is stored is included in the blacklist information 232.

In operation 540, when it is determined that the electronic device 101 is in the region where the refreshing of the identification is required, the processor 270 may refresh the identification information of the smart card 220 to update the identification information, based on the received network information.

In operation 550, the processor 270 may store the identification information before the update in the memory 230, and store the updated identification information in the smart card information 225.

In operation 560, the processor 270 may read the smart card information 225 to identify whether the updated identification information is included in the blacklist information 232.

In operation 565, when the updated identification information is not included the blacklist information 232, the processor 270 may allow the access to the smart card 220 and control the electronic device 101 to be normally operated.

In operation 570, when the updated identification information is included in the blacklist information 232, the processor 270 may identify whether the identification information before the update is stored in the memory 230.

According to an embodiment, when the identification information before the update is not stored in the memory 230, the processor 270 may proceed to operation 590 to be described later and restrict the access to the smart card 220 to block the function of the electronic device 101.

In operation 580, when the identification information before the update is stored in the memory 230, the processor 270 may identify whether the identification information before the update is included in the blacklist information 232.

In operation 590, when the identification information before the update is included in the blacklist information 232, the processor 270 may restrict the access to the smart card 220 to block the function of the electronic device 101.

According to an embodiment, when the identification information before the update is not included in the blacklist information 232, the processor 270 may proceed to operation 565, allow the access to the smart card 220, and control the electronic device 101 to be normally operated.

Accordingly, according to various embodiments of the disclosure, a user who uses the electronic device 101 such as a smartphone by normally buying same in a specific region (e.g., Europe) may not have a regional lock restriction due to the refreshing of the identification information of the smart card 220, which may occur during the visit to a country included in a blacklist.

Hereinabove, although the disclosure has been described according to various embodiments thereof, it will be appreciated that any changes and modifications made without departing from the scope of the technical spirit of the disclosure by those skilled in the art to which the disclosure belongs may also belong to the disclosure herein.

1. An electronic device comprising:
a wireless communication unit;
a smart card including smart card information in which identification information of the electronic device is stored;
a memory configured to store blacklist information; and
a processor electrically connected to the wireless communication unit, the smart card, and the memory,
wherein the processor is configured to:
refresh the smart card to update identification information when the electronic device is located in a predetermined region,
store information before the update of the identification information, in the memory,
store the updated identification information in the smart card information,
identify whether the identification information before the update is stored in the memory when the updated identification information is included in the blacklist information,
determine whether the identification information before the update is included in the blacklist information, and
allow access to the smart card when the identification information before the update is not included in the blacklist information.

2. The electronic device of claim 1,
wherein the processor is configured to restrict access to the smart card when the identification information before the update is included in the blacklist information.

3. The electronic device of claim 1, wherein the smart card information comprises at least one of an international mobile subscriber identity (IMSI), a mobile country code (MCC), a mobile network code (MNC), a mobile identification number (MIN), and a mobile subscriber identifier number (MSIN).

4. The electronic device of claim 1, wherein the blacklist information comprises, in order to restrict use of the electronic device, at least one of disallowable country information, mobile communication service provider information, the smart card information, network information, cell information, regional information, and base station information.

5. The electronic device of claim 1,
wherein the memory comprises a global variable region, and
wherein when the smart card is refreshed and the identification information is updated, the processor is configured to store the identification information before the update in the global variable region.

6. The electronic device of claim 1, further comprising a touch screen or an audio output unit,
wherein the processor is configured to:
display, on the touch screen, a user interface (UI) indicating allowance or restriction of access to the smart card, or
output an audio signal indicating allowance or restriction of access to the smart card, through the audio output unit.

7. The electronic device of claim 1, further comprising a power manager,
wherein the processor is configured to determine whether to boot the electronic device according to whether the smart card information is included in the blacklist information.

8. An access control method for a smart card included in an electronic device, the method comprising, as operations performed by a processor:
refreshing the smart card to update identification information when the electronic device is located in a predetermined region;
storing information before the update of the identification information, in a memory;
storing the updated identification information in smart card information of the smart card; identifying whether the identification information before the update is stored in the memory when the updated identification information is included in blacklist information of the memory;
determining whether the identification information before the update is included in the blacklist information when the identification information before the update is stored in the memory; and
allowing access to the smart card when the identification information before the update is not included in the blacklist information.

9. The method of claim 8, further comprising restricting, by the processor, access to the smart card when the identification information before the update is included in the blacklist information.

10. The method as claimed in claim 8, further comprising, as operations performed by the processor:
determining whether the smart card requires refreshing of the identification information stored in the smart card information;
determining whether the smart card information stored in the identification information before the update is included in the blacklist information when the smart card does not require the refreshing of the identification information; and
receiving network information of a region where the electronic device is located when the smart card requires the refreshing of the identification information.

11. The method of claim 10, comprising, as operations performed by the processor:
determining whether the electronic device is in a region where the refreshing of the identification information is required, based on the received network information; and
determining whether the smart card information stored in the identification information before the update is included in the blacklist information when it is determined that the electronic device is not in the region where the refreshing of the identification is required.

12. The method of claim 8, further comprising:
reading, by the processor, the smart card information to identify whether the updated identification information is included in blacklist information.

13. The method of claim 8, comprising:
allowing, by the processor, access to the smart card when the updated identification information is not included in the blacklist information.

14. The method as claimed in claim 13, comprising, as operations performed by the processor:
identifying whether the identification information before the update is stored in the memory when the updated identification information is included in the blacklist information; and
restricting access to the smart card when the identification information before the update is not stored in the memory.

15. A non-transitory computer-readable storage medium in which a program configured to perform an access control method for a smart card included in an electronic device is stored, the method comprising:
refreshing the smart card to update identification information when the electronic device is located in a predetermined region;
storing information before the update of the identification information, in a memory;
storing the updated identification information in smart card information of the smart card;
identifying whether the identification information before the update is stored in the memory when the updated identification information is included in blacklist information of the memory;
determining whether the identification information before the update is included in the blacklist information when the identification information before the update is stored in the memory; and
allowing access to the smart card when the identification information before the update is not included in the blacklist information.
